(19) United States
(12) Patent Application Publication
(10) Pub. No.: US 2025/0149236 A1
(43) Pub. Date: May 8, 2025

(54) REDUCTION OF EDDY CURRENT LOSS INDUCED BY LEAKAGE MAGNETIC FIELD IN TRANSFORMERS AND INDUCTORS

(71) Applicant: UNIVERSITY OF TENNESSEE RESEARCH FOUNDATION, Knoxville, TN (US)

(72) Inventors: Fei Wang, Knoxville, TN (US); Zihan Gao, Knoxville, TN (US)

(21) Appl. No.: 18/939,020

(22) Filed: Nov. 6, 2024

Related U.S. Application Data
(60) Provisional application No. 63/547,470, filed on Nov. 6, 2023.

(51) Int. Cl. H01F 27/36; H01F 27/245; H01F 27/25; H01F 27/34

(52) U.S. Cl. CPC H01F 27/366; H01F 27/245; H01F 27/25; H01F 2027/348

(57) ABSTRACT

Various examples are provided related to the reduction of eddy current loss induced by the leakage field in transformers and inductors. In one example, a transformer includes a 2D laminated magnetic core; a first winding wound about the 2D laminated magnetic core; and a second winding wound about the 2D laminated magnetic core adjacent to the first winding. The first and second windings can operate at first and second voltage levels. In another example, an inductor includes a 2D laminated magnetic core including two halves separated by airgaps; and a winding wound about the 2D laminated magnetic core.

### CROSS REFERENCE TO RELATED APPLICATIONS

This application claims priority to, and the benefit of, co-pending U.S. provisional application entitled “Reduction of Eddy Current Loss Induced by Leakage Magnetic Field in Transformers and Inductors” having Ser. No. 63/547,470, filed Nov. 6, 2023, which is hereby incorporated by reference in its entirety.

### STATEMENT REGARDING FEDERALLY SPONSORED RESEARCH OR DEVELOPMENT

This invention was made with government support under grant numbers DE-EE0008410 and DE-EE0009134 awarded by the Department of Energy. The government has certain rights in the invention.

### BACKGROUND

Medium-voltage (MV) dual-active-bridge (DAB) converters have become an emerging technology thanks to high-voltage silicon carbide (SiC) devices and nanocrystalline magnetic materials. However, the need of phase-shift inductance and insulation requirements for the MV DAB may complicate the design of the transformer and the MV DAB converter, which can also induce higher loss and occupy more space. The eddy current issue caused by leakage or fringing magnetic field is relatively unknown because such effect is relatively small in traditional transformers and inductors with laminated cores, where the leakage magnetic field is small. In some applications, such as high-power high frequency transformers and inductors using laminated magnetic cores, the issue can become pronounced and incur significant extra loss.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C illustrate examples of 2-dimensional (2D) laminated magnetic core configurations for transformers and inductors, in accordance with various embodiments of the present disclosure.

FIGS. 2A and 2B illustrate examples of shielding layer configurations for a ribbon-based 2D transformer and a sheet/block-based 2D transformer, respectively, in accordance with various embodiments of the present disclosure.

FIG. 3 illustrates an example of a gapped inductor, in accordance with various embodiments of the present disclosure.

FIG. 4 is a thermal image of a leakage inductance integrated core-type transformer with high eddy current loss, in accordance with various embodiments of the present disclosure.

FIGS. 5A and 5B illustrate an example of a proposed transformer structure for leakage integration, in accordance with various embodiments of the present disclosure.

FIG. 6A illustrates leakage inductance and resistance measurement test results of the ferrite bridge, in accordance with various embodiments of the present disclosure.

FIG. 6B is a thermal image showing a transformer with the ferrite bridge during short circuit testing, in accordance with various embodiments of the present disclosure.

FIGS. 7A and 7B illustrate examples of transformer short-circuit simulations with the proposed structure in a one-piece transformer core and split transformer cores, respectively, in accordance with various embodiments of the present disclosure.

FIG. 8 is a thermal image showing a transformer with split core during short circuit testing, in accordance with various embodiments of the present disclosure.

FIGS. 9A and 9B are an image of a MV DAB transformer and DAB power stages and a table illustrating design parameters of the transformer, respectively, in accordance with various embodiments of the present disclosure.

FIGS. 10A and 10B illustrate examples of test results for MV DAB transformer/converter under no-load and full-load conditions, respectively, in accordance with various embodiments of the present disclosure.

FIG. 11 illustrates examples of a bar shield, hybrid core structure, and proposed shielding, in accordance with various embodiments of the present disclosure.

FIG. 12 illustrates an example of the proposed ferrite shielding for gapped inductors, in accordance with various embodiments of the present disclosure.

13A and 13B illustrates examples of flux line with proposed ferrite shielding (top and perspective views), in accordance with various embodiments of the present disclosure.

FIGS. 14A and 14B are images of a shielded inductor and amorphous core with proposed shielding, respectively, in accordance with various embodiments of the present disclosure.

FIGS. 15A-15C illustrate examples of inductor simulation results showing unshielded, current density; shielded, current density; and shielded, flux density, respectively, in accordance with various embodiments of the present disclosure.

FIGS. 16A-16C are thermal images showing an unshielded and shielded inductor and inductor waveforms during testing, in accordance with various embodiments of the present disclosure.

FIG. 17 illustrates a loss comparison between unshielded and shielded inductors, in accordance with various embodiments of the present disclosure.

FIGS. 18A and 18B are images showing an example of a core-type transformer, and its transformer core with ferrite shielding, in accordance with various embodiments of the present disclosure.

FIGS. 19A and 19B schematically illustrate transformer test setups for a short-circuit test and DAB power pump back test, respectively, in accordance with various embodiments of the present disclosure.

FIGS. 20A-20D illustrate examples of core-type transformer simulation results for unshielded, flux density; unshielded, surface current density; shielded, flux density; and shielded, surface current density, respectively, in accordance with various embodiments of the present disclosure.

FIGS. 21A and 21B are thermal images showing unshielded and shielded core-type transformers during short circuit testing, in accordance with various embodiments of the present disclosure.

FIGS. 22A and 22B show an example of a transformer waveform and a loss comparison between unshielded and proposed shielded transformer core from core-type transformer testing, in accordance with various embodiments of the present disclosure.

FIGS. 23A and 23B are images showing an example of a shell-type transformer, and its transformer core with ferrite shielding, in accordance with various embodiments of the present disclosure.

FIGS. 24A-24D illustrate examples of shell-type transformer simulation results for unshielded, flux density; unshielded, surface current density; shielded, flux density; and shielded, surface current density, respectively, in accordance with various embodiments of the present disclosure.

FIGS. 25A and 25B are thermal images showing unshielded and shielded shell-type transformers during short circuit testing, in accordance with various embodiments of the present disclosure.

FIG. 26 shows an example of a DAB test waveform for shell-type transformer, in accordance with various embodiments of the present disclosure.

FIG. 27 shows a loss comparison in DAB test with unshielded and shielded shell-type transformers, in accordance with various embodiments of the present disclosure.

### DETAILED DESCRIPTION

Disclosed herein are various examples related to the reduction of eddy current loss induced by the leakage field in transformers and inductors. A method to mitigate the eddy current and corresponding loss in magnetic components, such as transformers and inductors, due to the leakage magnetic flux and fringing effect is introduced. A two-dimensional lamination structure for the magnetic core as well as ferrite shielding layers are proposed. The eddy current can be suppressed by the smaller lamination surface area and further reduced by the shielding layer. Reference will now be made in detail to the description of the embodiments as illustrated in the drawings, wherein like reference numbers indicate like parts throughout the several views.

Here, a methodology is presented to suppress eddy currents caused by leakage or airgap fringing magnetic field in transformers and inductors built with laminated core materials. Using this method, the transformer and inductor loss can be reduced, and leakage integration can be efficiently realized, for high frequency transformers. Additional features can include:
Ferrite shielding, which can limit the eddy current loss. The reduction may be limited by the pattern of the shielding.
Low leakage transformer configuration can realize low eddy current by the nature of the configuration. In some cases, the leakage integration into the transformer considers the power density.
Stacking smaller and/or narrower transformer cores can reduce eddy current by providing a smaller surface area. The geometry may be limited due to manufacturability and may only be applicable to limited types of transformer cores.

Compared with the traditional methods, the proposed methodology can be more effective at the reduction of leakage induced eddy current in the transformers/inductors. First, two-dimensional lamination can be realized for not only the ribbon-based magnetic cores, but also in block or lamination sheet-based transformers/inductors. A new type of magnetic conductive wire-based core is proposed such that the eddy current can be minimized with less surface area. Also, a new pattern of ferrite shielding is introduced. With the shielding creating a magnetic path to the main transformer core, the leakage field can be bypassed to the ferrite shielding layer. Hence, the main core has less leakage field and the eddy current can be further reduced.

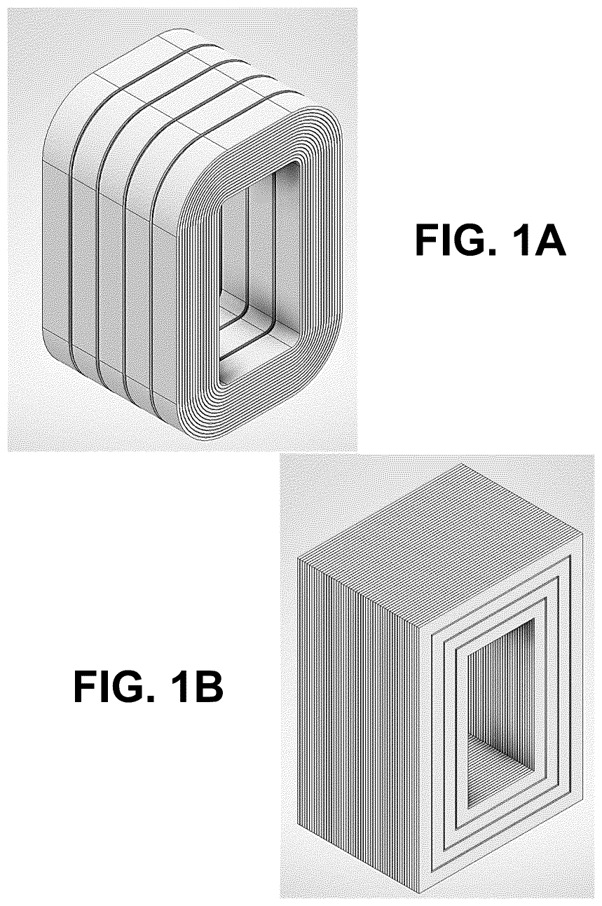

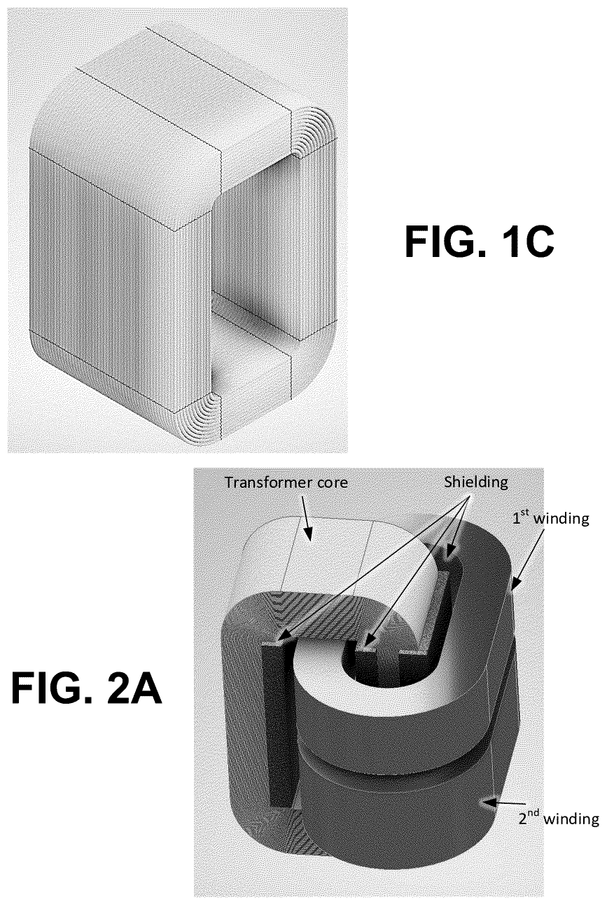

A two-dimensional lamination can be used in the magnetic core to reduce eddy currents. In addition, a better shielding can be provided between the core and windings. FIGS. 1A-1C illustrate examples of different possible configurations of 2-dimensional (2D) laminated magnetic cores for transformers and inductors. FIG. 1A shows an example of a ribbon-based 2D lamination core, FIG. 1B shows an example of a sheet-based 2D lamination core (which can be extended to a block-based 2D core), and FIG. 1C shows an example of a wire-based 2D lamination core.

In FIG. 1A, the ribbon-based 2D lamination core includes a stack of narrow ribbon cores. The magnetic core can be laminated with narrow magnetic alloy ribbons, and the ribbon can be wound in several layers both radially and axially, to form the two-dimensional array. The laminated structure can also be used as shown in FIG. 1B, where silicon steel sheets or nanocrystalline bars/blocks can be used to form the core. Either silicon steel sheets cut into narrower width or block/bars manufactured into narrower geometry, the cores can be formed with stacking (or nesting) them in two directions to form the 2D lamination. Furthermore, if magnetic alloy wires are available, the magnetic core can be made by winding the wire radially and axially to form the core as shown in FIG. 1C. The wire can be broken into sections to minimize any induced currents.

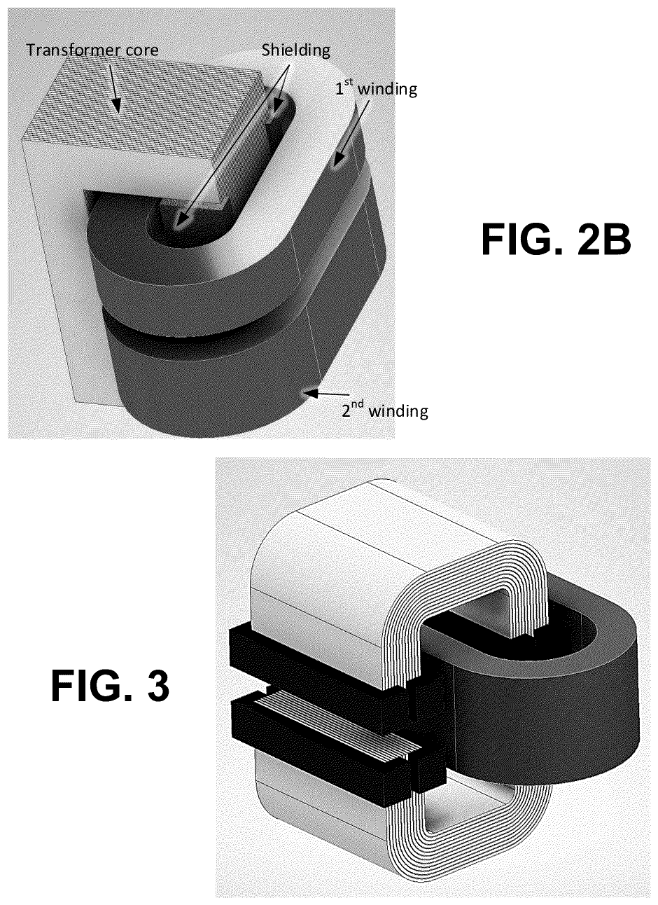

In addition, a shielding layer can be applied to the lamination surface of the magnetic cores. FIGS. 2A and 2B illustrate examples of shielding layer configurations for a ribbon-based 2D transformer and a sheet/block-based 2D transformer, respectively. The shielding layer can cover the core surface that experiences high eddy current (parallel or substantially parallel to the lamination plane) due to the leakage magnetic field in the transformer, or the fringing magnetic field in the inductor. The shielding layer can extend around the corners of the magnetic core to the side surface of the laminations, which is the surface perpendicular to the lamination plane. With this, the leakage or fringing flux can be bypassed from the magnetic core to the air by the shielding magnetic layers.

As seen in the example of FIG. 2A, shielding layers are provided on both sides of the core that passes through the first and second windings and on the side of the core that passes next to the windings. The shielding layers only partially cover the side surfaces of the magnetic core. In the example of FIG. 2B, shielding layers are provided on both sides of the core that passes through the first and second windings and partially extend along the side surfaces perpendicular to the lamination plane. This applies to sheet-based and block-based 2D cores.

FIG. 3 shows an example of a gapped inductor, which can be used to suppress fringing field induced eddy current loss. The ribbon-based 2D lamination core may include shielding layers on both sides of the gap.

This methodology can also be applied to multi-winding transformers and inductors. Different core materials based on laminations such as, e.g., silicon steel, nanocrystalline, and amorphous, and other alloys for magnetic applications can be utilized. The magnetic core may be gapped to provide inductance control or for assembly of the transformer or inductor. The shielding layer material can comprise, but is not limited to, ferrite. Other materials such as, e.g., magnetic powder composites that are magnetically conductive while exhibiting low electrically conductivity can also be used to suppress the eddy current.

Medium-Voltage Transformer with Integrated Leakage Inductance

Medium-voltage (MV) dual-active-bridge (DAB) converters have become an emerging technology thanks to the high-voltage silicon carbide (SiC) devices and nanocrystalline magnetic materials. However, the need of phase-shift inductance and insulation requirements for the MV DAB may complicate the design of the transformer and the MV DAB converter, which can also induce higher loss and occupy more space. In this disclosure, the leakage integration and insulation techniques are discussed with respect to a 6.7-kV/850-V DAB converter, meeting both the inductance and insulation needs of the MV DAB converter. Ferrite cores with air gaps can be inserted between the LV and MV windings without introducing high loss, and the MV winding can be selectively shielded to avoid high parasitics and meet the insulation requirement. Test results have verified the effectiveness of this design.

MV dc/dc converters have been widely implemented where high power and high voltage conversion are needed. Fast-switching and high-voltage wide band-gap semiconductor devices, as well as low loss and high saturation magnetic materials, have enabled more compact and efficient designs of the MV dc/dc transformers and converters, making the converters more efficiency and power dense.

Over the years, there have been several successful MV transformer designs. Hollowed shielded cable was utilized as the transformer winding, since the inner conductor and outer shielding can be seen as two set of windings having a 1:1 turns ratio, with a good insulation rating, and the center hollowed channel of the cable was used to provide coolant path for active winding cooling. An oil-type MV transformer was implemented in a 1.2 MVA shunting locomotive, similar to the conventional traction transformers, the transformer oil can serve as both the insulation material and the liquid coolant. The solid-state transformer (SST) is also a typical application, for microgrid, datacenter, or renewable energy generation. A GaN/SiC-based converter for the datacenter was proposed, by increasing the switching frequency up to 500 kHz to achieve a high-power density.

A transformer was introduced with casted silicone and epoxy to improve the insulation performance, and the MV winding was coated with a shielding layer to confine the electric field in the dielectric material inside the MV winding, so that the low voltage winding does not need to be encapsulated and has better cooling. 10 kV SiC devices were used as the MV side switch, so that the single stage can be realized for 7 kV to 400 V conversion. An air-insulated transformer was introduced, having a very high power density as all the winding conductors can be directly cooled by the air flow. An air-core transformer has been designed to have light weight. As the air core cannot constraint the magnetic field, proper magnetic shielding is needed.

Leakage Integration. For dual-active-bridge converters, the transmitting power is determined by the phase-shift and the series inductance between the two bridges. The series inductance for DAB converters should be sufficient for stable power conversion and also realizing zero voltage switching (ZVS) to reduce switching losses. It should also be noted that the series inductance may also need MV insulation, which can also impact the volume and power density of the converter design, and hence may need to be integrated into the transformer.

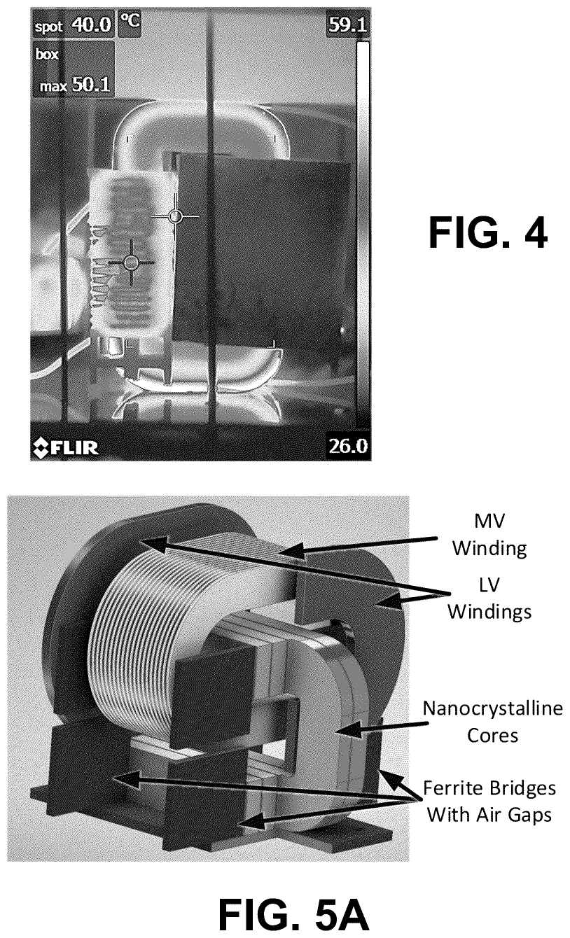

An important effect on a nanocrystalline tape-wounded transformer is the eddy current in the lamination surfaces. As the lamination is mainly for eliminating the eddy current component in the magnetizing loop to reduce the core loss, it may not work on the leakage loop and may cause high eddy current loss. FIG. 4 shows a thermal image during a short circuit test of a core-type MV transformer, and as can be seen the temperature distribution of the core is strongly uneven. Most of the heat has been concentrated on the outer surface of the core, where the eddy current is mainly concentrated. Similar phenomena have also been found in previous work. To tackle this issue, a ferrite shielding method can be introduced to bypass the leakage flux so that the eddy current may not be generated in the lamination, but the effect is limited by test verification. Core type transformers can have high leakage inductance, and some of the leakage can be made further by central legs, and the adapted leakage layers can reduce the eddy current loss to a significant low level. However, the structure of the dry-type MV winding needs to be fit into the core window with limited space, making the manufacturing process complicated.

Insulation and Parasitic Capacitance. The promising and environmentally friendly way of transformer insulation should be the dry-type insulation, which utilizes solid materials such as epoxy, silicone, or polyurethane as the insulation material, instead of using transformer oil. However, as the dielectric constants of the epoxy or silicone are usually above 3, while the transformer oil typically has a dielectric constant of 2.1-2.4, the parasitic capacitance of the dry-type transformer should have a larger parasitic capacitance. To confine the electric field of MV winding, and reduce common-mode electromagnetic interference, the MV winding may be shielded on the surface of the solid insulation, so that the LV windings and cores are not necessary to be encapsulated or casted, and therefore, the transformer cooling can be easier. However, due to the electric shielding on MV winding, the parasitic capacitance between the winding and ground also increases drastically. In some applications, e.g., cascaded H-bridge (CHB) invertors, the common-mode voltage swing can be imposed on the transformer grounding capacitance, causing significant switching losses on the CHB side devices. The transformer in dc/dc operation has high current spikes when the CHB devices switch and charge/discharge the parasitic grounding capacitance, causing significant switching losses. To reduce this effect, partial shielding can be chosen, so that only the affected surfaces are shielded while the other sides can remain unshielded.

### Low Loss Leakage Integration

A new leakage integration method having low eddy current loss is introduced using ferrite structures, and splitting nanocrystalline cores. Dry-type transformer insulation consideration with partial shielding will be discussed. First, the leakage field of different types of transformer structures will be demonstrated, and the new structure having low eddy current loss will be introduced. Then, the dry-type insulation strategy will be discussed, with partial shielding. The transformer design based on the aforementioned method will be briefly discussed, and the test results will be shown.

Leakage Integration with Ferrite Bridge. To begin with, the leakage inductance of the MV transformer should be clarified as the combination of the intrinsic leakage inductance that the transformer structure itself possesses without any external structures, and the external inductance that produced by structures which are artificially added to the transformer, i.e.,

$${L}_{l} = {L}_{i} + {L}_{e} , \qquad ( 1 )$$

where Lₗ is the leakage inductance, Lᵢ is the intrinsic leakage inductance, and Lₑ is the external inductance. To find the transformer structure with low eddy current loss and high leakage integration capability, the intrinsic inductance should be minimized in order to have low leakage loss, while the external inductance should be maximized to a level that is desired for the transformer design.

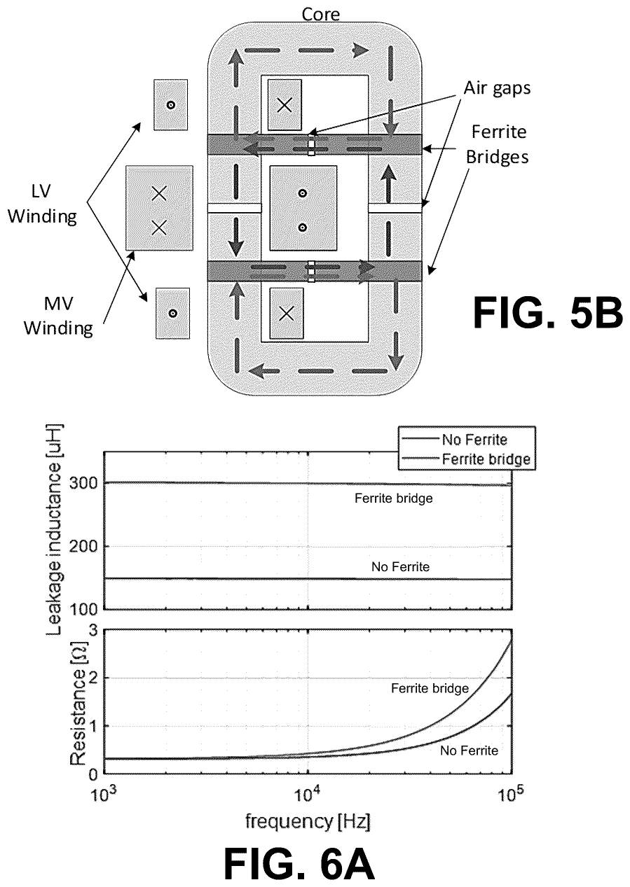

One possible structure having low intrinsic leakage inductance is the shell-type transformer. However, the co-axial shell-type transformer is excluded, as the LV and MV winding placed together may compromise the transformer cooling and make the leakage integration complicated. As in shell type transformers, the windings can be split or interleaved, a new structure can be found with low intrinsic leakage and can be externally integrated with ferrite structures. An example of the new structure is shown in FIG. 5A. FIG. 5B is a cross-sectional view showing an example of the ferrite bridge placement. As the LV winding is split into two sets, and interleaved with the MV winding, the intrinsic leakage flux should be lower compared to the core-type and non-interleaved conventional transformer so that the eddy current should be low.

However, thanks to the ferrite bridges added between the LV and MV windings, high external leakage flux can be added and tuned by the air gaps. Even though the ferrite may introduce ferrite core loss when the transformer is loaded, as long as the flux density in the ferrite does not saturate, and the volume of the ferrite is relatively small, the overall loss when at short-circuit should be low compared to the other methods.

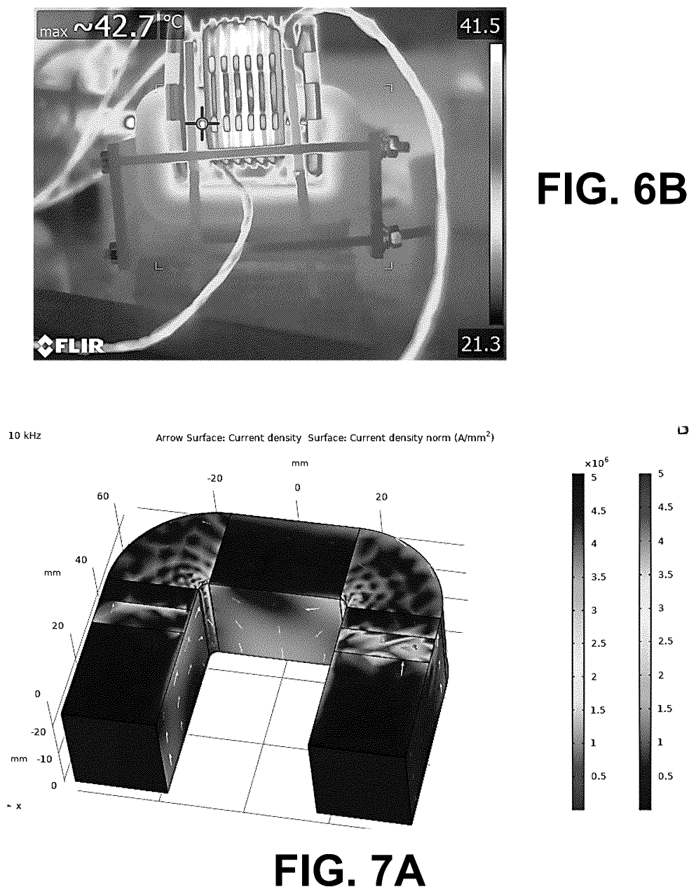

To verify the effectiveness of different structures, quick tests have been performed to test the losses and leakage inductance of the proposed structure. To make fair comparison, the windings and core are set to the same as in FIG. 4. In FIG. 6A, as can be seen, without the ferrite bridge, the leakage inductance is around 150 μH, which is corresponding to Lᵢ in Eq. (1), while after the ferrite bridge is inserted, the leakage inductance increased to around 300 μH. That is, the external inductance of 150 μH has been added into the transformer. From FIG. 6B, the thermal image shows that unlike in FIG. 4 where the outer surface of the core was heated up, the surface of the inner window in FIG. 6B was slightly heated, and the temperature rise is lower than in FIG. 4. The estimated eddy current loss is around 33 W, while in FIG. 4 it used to be 105 W.

Eddy Current Loss Reduction by Splitting Transformer Core. As can be seen in FIGS. 6A-6B, the shell-type transformer with interleaved winding still has some amount of eddy current loss on the inner surface of the transformer core, which may need to be further reduced. Note that the lamination reduces the eddy current loss by cutting the solid area perpendicular to the magnetic field smaller, similar strategy has also been adopted to reduce the gap losses for tape-wounded nanocrystalline cores. Same measure can also be taken to reduce the eddy current loss induced by the leakage inductance.

Therefore, simulations with split cut cores were performed. Originally, the transformer core used was 50 mm in depth, and can be replaced with 5 thinner cores with 10 mm in depth, as it can be easily wound with 10 mm wide nanocrystalline tape without any cutting process.

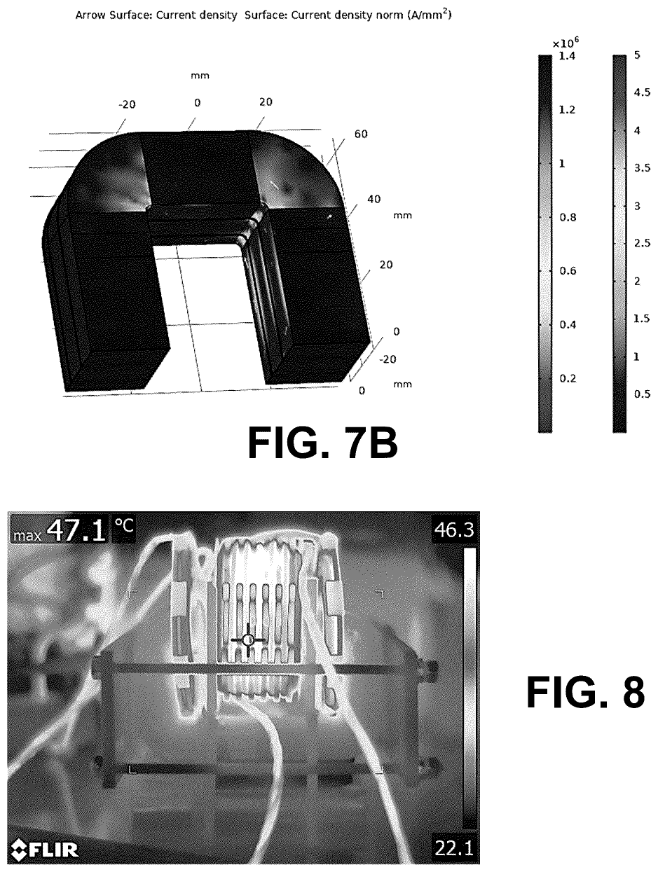

Simulations have been performed to make the comparison and the results are shown in FIGS. 7A and 7B. In FIG. 7A, the original one-piece transformer core was used with 50 mm in depth, and in the inner window surface the current density of 2 A/mm² can be found with a wide range, and the loss was measured as 28 W. For FIG. 7B, the cores were cut into 5 smaller cores (mirrored part not shown). The area having eddy current significantly shrank, only the edge regions have some current density around 2 A/mm², and the eddy current loss was measured as 9.4 W, which was 60% further reduced.

To verify the results, tests were also done with replaced customized cores. From FIG. 8, the temperature of the eddy current surfaces was further decreased, so did the total losses. For the proposed interleaved shell-type transformer, the total loss was reduced to 111 W, and the estimated eddy current loss reduced to 9 W. From the thermal image it can be seen that the inner surface of the core no longer has a hot spot. Therefore, the split core can further reduce the eddy current loss induced by the leakage flux.

### Transformer Test

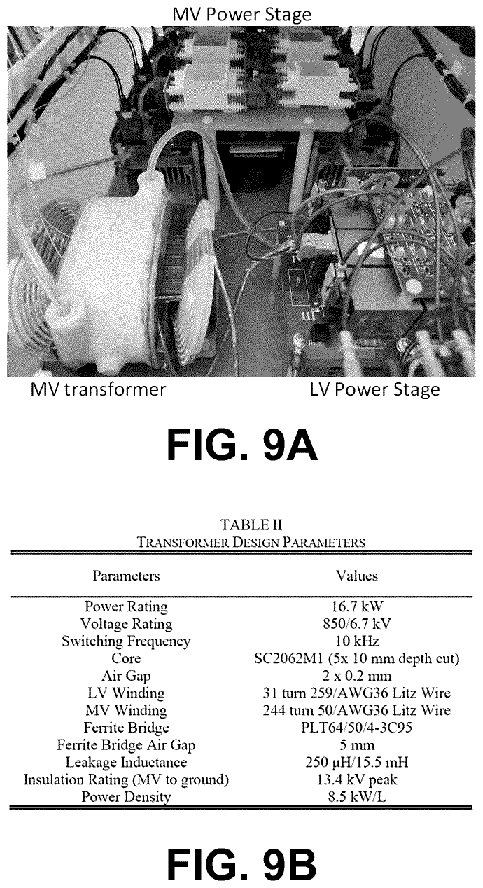

Transformer design. With the proposed leakage integration and insulation, a MV DAB transformer was designed for a 10 kV SiC-based DAB converter, serving as a front end of a CHB inverter. A photograph of the MV transformer with LV and MV power stages is shown in FIG. 9A. The design parameters of the transformer are shown in the table of FIG. 9B.

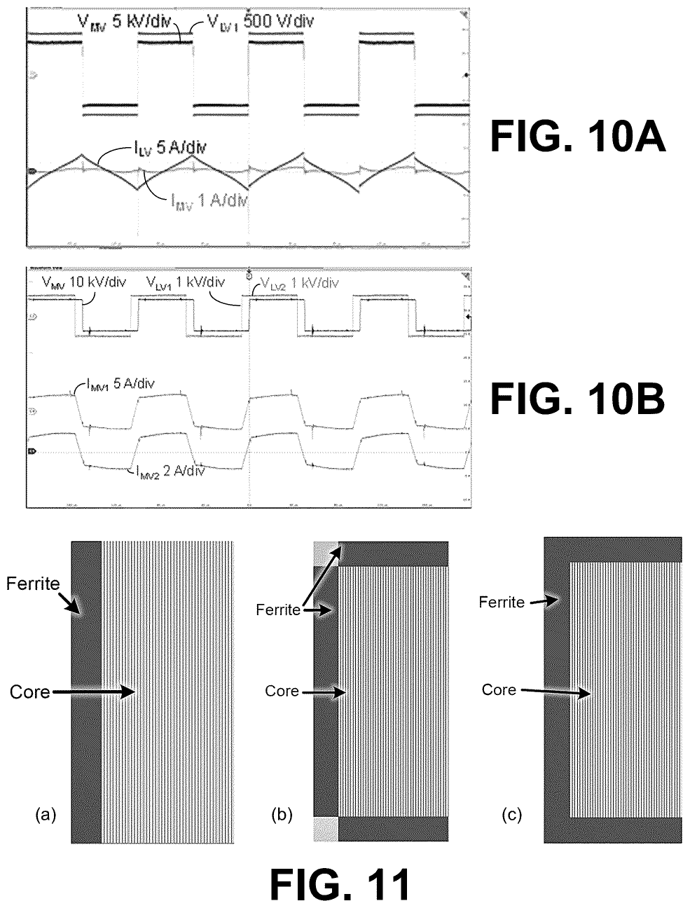

Transformer Test. Two transformers were installed in the DAB converter and connected with the CHB converter forming a two-stage converter, tested from no-load to full load condition. The test waveforms are shown in FIGS. 10A and 10B. From the test waveforms, the transformer worked as expected. DAB transformers for both no-load and full-load conditions, and the waveforms of two transformers agreed with each other. From the test, the total loss of transformer was estimated as 119.52 W, achieving an efficiency of 99.3%, and the eddy current loss was estimated as 33 W.

In this disclosure, a MV transformer design with low-loss leakage integration, as well as insulation design with field shaping has been introduced. Through simulation and tests, the shell-type transformer with interleaved LV winding and ferrite structures have been shown to have better leakage integration capability and loss performance. The split transformer core can further reduce the eddy current loss induced by the leakage magnetic field, without sacrificing power density and other performances, but the specification of the manufacturer should be followed when customizing the split cores. The insulation materials and insulation structure have been discussed to improve the insulation performance. Partial shielding is needed for the MV winding design because of reduced grounding capacitance, which may impact the switching losses of the converter having common-mode swings. Based on the discussions, a 850-V/6700-V 16.7 kW MV DAB transformer was designed and tested. The MV winding passed the PD standard in IEEE Std C57.12.91, and the whole two-stage converter system achieved 98% power efficiency at full load condition, with the transformer having a power density of 8 kW/L and insulation capability of 13.4 kV.

### Ferrite Shielding for Eddy Current Suppression on Inductors and Transformers

Ribbon-based magnetic cores, such as nanocrystalline and amorphous cores, have been widely used in inductors and transformers in high power converters. However, unwanted eddy current can be found on the surfaces of the core laminations due to fringing effect and leakage magnetic field. In this disclosure, a ferrite shielding structure is proposed to create bypass loops for lamination layers to avoid the stray field crossing the lamination layers. The mechanism of the proposed shielding is demonstrated. Simulations and tests have proved the effectiveness for the gapped inductor, as well as core and shell-type transformers.

Passive components, i.e. inductors, capacitors, and transformers, play important roles in power electronic converters or power electronics-based circuit breakers, such as energy/charge storage, isolation and filtering. The volume and loss of the passive components are usually concerned to improve the converter performance. Ribbon-based magnetic cores, including nanocrystalline and amorphous cores, have been widely used for inductors and transformers in high power electronic converters. The ribbon-based cores are wound from thin (15˜25 μm) magnetic alloy ribbons into O-shaped loops, and then can be cut into different shapes. The ribbons have surface insulation to insulate between different layers to suppress the eddy current generated by the mainstream flux flowing along the core geometry. Thanks to the high saturation flux density, compact passive design can be achieved for medium voltage high power converters. However, as the ribbon structure creates lamination layers, stray magnetic field going perpendicular to the lamination layer can cause high magnetic field. For some inductors or transformers, the stray magnetic field can emit into the air and cause interference to itself or other system, and in some cases, high eddy current and extra loss can be generated. As the leakage field is generated by the arrangement of the windings and core, the leakage field can be different with different winding placement, yet the electromagnetic interference (EMI) can also be different. In the cases of fringing effect of air-gapped inductors, or leakage integration for transformers, considerable magnetic field can be generated in the direction orthogonal to the lamination plane, and hence extra eddy current is generated, causing unexpected high core loss and heat on the core surfaces.

### Proposed Ferrite Shielding Structure

In this disclosure, a ferrite shielding structure is proposed considering both fringing effect for inductors and leakage integration for transformers. The shielding area can be minimized by forming ferrite corners and redirecting stray field into ferrite directly from inner laminations. A proposed strategy of ferrite shielding is introduced. Case studies on implementation and verification on fringing effect for amorphous inductor and leakage integration for core-type transformer are provided.

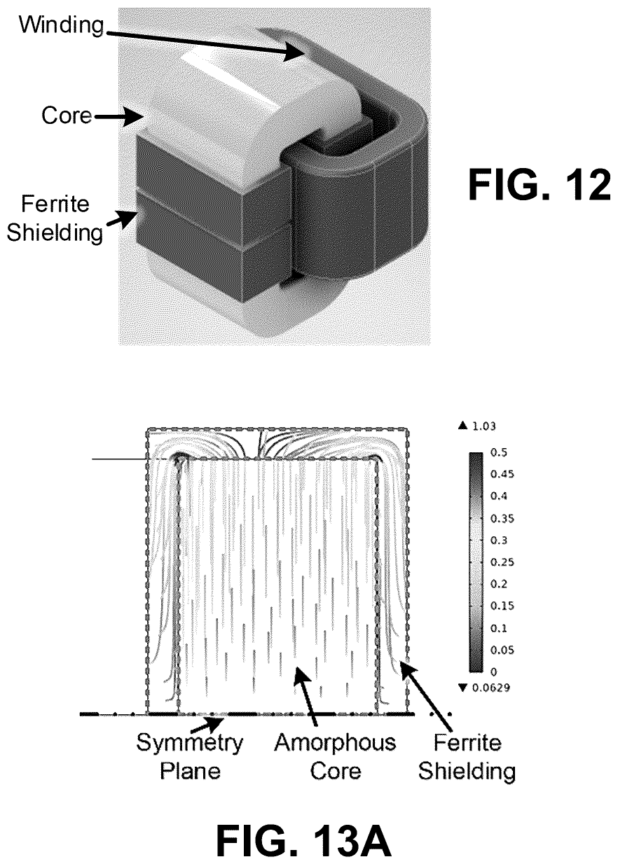

The conceptual drawing of the conventional shielding and proposed structure is shown in FIG. 11, which shows examples of (a) a bar shield, (b) a hybrid core structure, and (c) the proposed shielding. The proposed ferrite shielding extends to the two side surfaces of the cores, which exposes the edges of each lamination layer, and the ferrite covering adjacent faces are physically connected together. To better understand the proposed method, the proposed shielding for a gapped inductor case is illustrated in FIG. 12. In gapped inductors, the fringing effect happens at the vicinity of gapped area, with flux escaping into the air from the core cut area and side surfaces, and especially for ribbon-based cores, the fringing effect can cause high eddy current due to the lamination orientation of the cores. The proposed ferrite shielding is on the surfaces expected to see high stray magnetic field, and the shielding is also further extended with right angle to the two sides of the core. Therefore, a low reluctance path can be formed for the stray flux passing the core lamination to the air, without directly crossing the lamination planes. FIGS. 13A and 13B (top and perspective views) show that with the proposed ferrite shielding, the flux can be shaped in a way that the flux line is in parallel with the lamination plane, suppressing the eddy current to minimum by the ribbon thickness, and the flux can be redirected by the lossless ferrite into the air gap.

### Case Studies on Inductors and Transformers

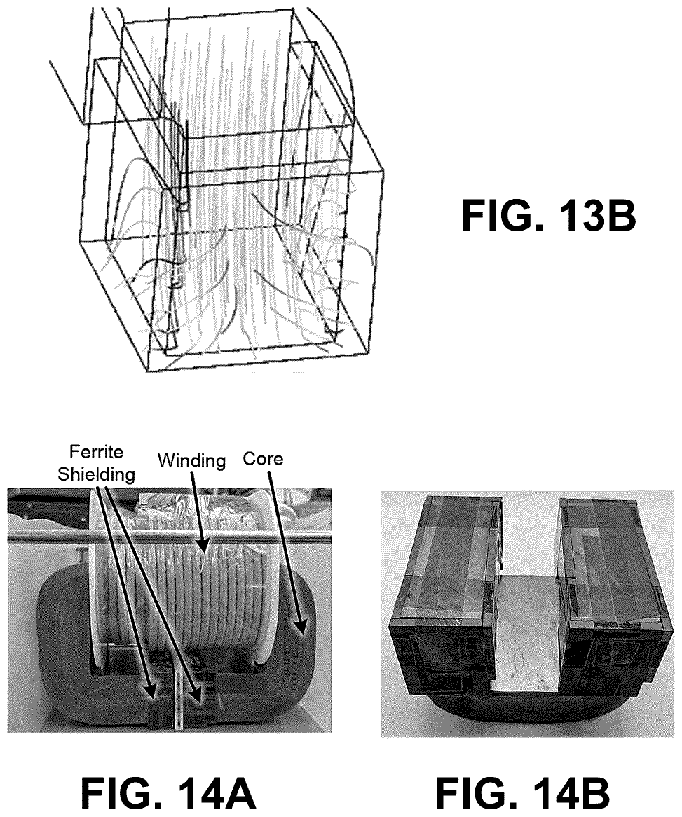

Ferrite Shielding on Gapped Inductors. The proposed method is first implemented in amorphous based inductors thanks to its simplicity. FIG. 14A shows the mechanical assembly of the proposed inductor. The inductor uses an AMCC1000 amorphous core, and multiple ferrite plates at the vicinity of air gaps, surrounding both the lamination planes and the core sides (see FIG. 14B). In order to keep the inductance (1.4 mH) unchanged, the air gap with no shielding was set to 5 mm for each leg, and 6.5 mm for the shielded inductor as the shielding inevitably added a portion of cross-sectional area in air gap. As the ferrite shielding was added, the dimensions of the actual inductor core were larger. Therefore, the shielded inductor was 5 mm higher height compared to the unshielded inductor, which enlarged the inductor size from 4.22 L to 4.36 L, by 3%.

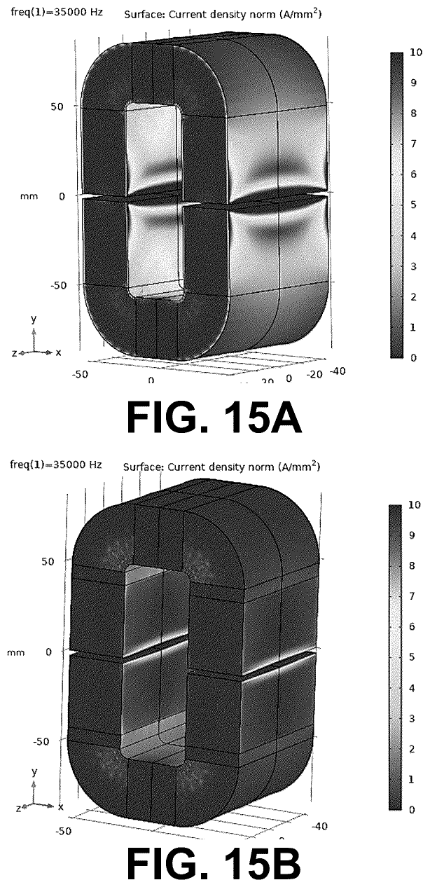

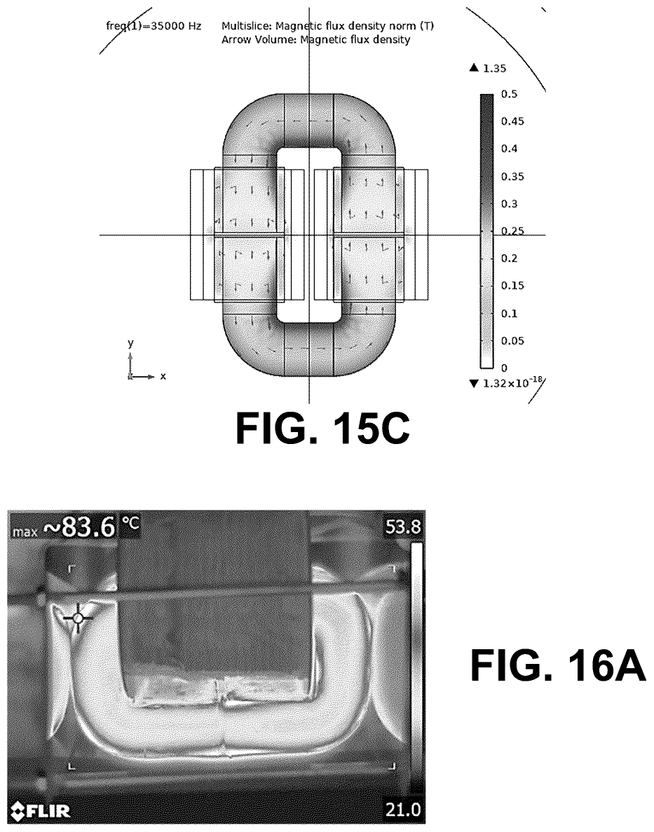

A simulation was performed to compare unshielded and shielded inductors, and selected results are shown in FIGS. 15A-15C. FIGS. 15A-15C show inductor simulation results for unshielded current density; shielded current density; and shielded flux density, respectively. The lamination can be modeled as individual layers if toroidal core or simple core structure is used with high computation capability, yet the ribbon-based C-core is with high computation capability, yet the ribbon-based C-core has different core orientations for the legs, corners and yokes. Instead, it was homogenized for different sections. From FIGS. 15A-15C, it can be seen that without the shielding, the surface current density can be over 10 A/mm² at the corners close to air gap, while when the ferrite added, the current can be significantly reduced, with most of the areas close to 0. From the simulation, the estimated eddy current loss can be reduced by 82%. The concern on the ferrite application with ribbon-based core is usually the mismatch of saturated flux level, and it can be found in FIG. 15C that, with a main flux density of 0.4 T, the flux density within ferrite is lower than 0.15 T, which is below the saturation level of the ferrite.

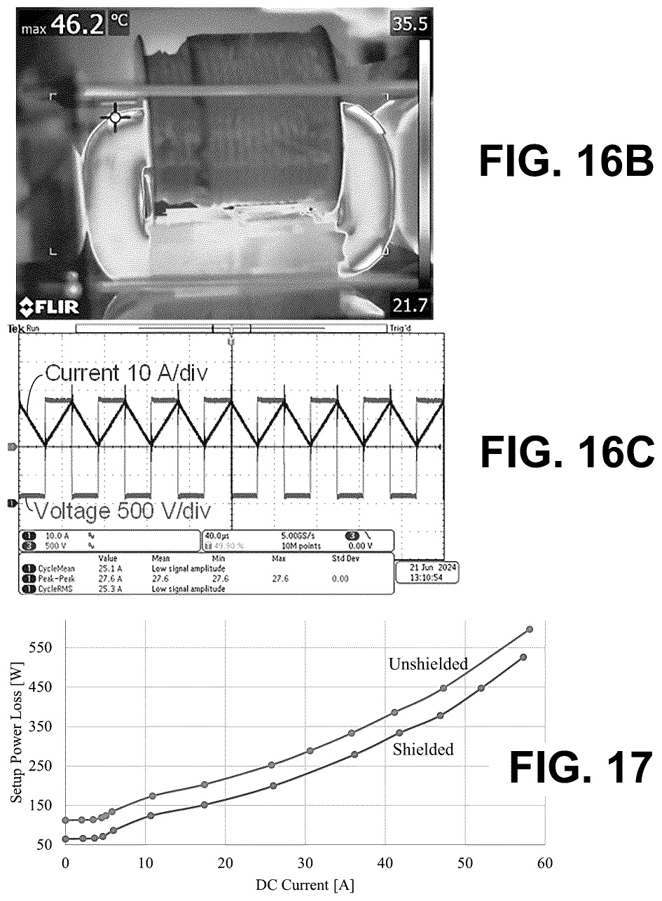

Then, to test the effectiveness of the proposed ferrite shielding, the inductor was excited with DC biased current. Thanks to the same inductance of the inductors under test, the current waveform and power losses of the H-bridge should be similar and not affect the inductor loss evaluation. FIGS. 16A and 16B show the thermal image of the inductor test without DC bias current to show the hot spot on lamination surface, and FIG. 16C shows the test waveform at rated current. The power losses are shown in FIG. 17, and as the DC current increases from 0 A to 57 A, the power loss stays constant at first due to the devices transited from ZVS to hard switching condition. At below 5 A, regardless of the current level, the reduction is constant which is around 69 W, because the current ripple in the inductor is always constant at low DC biased voltage, and therefore the flux density ripple and eddy current remains constant. At around 57.3 A, the reduction decreases, which is due to partial saturation of ferrite shielding. At that level, the main amorphous core flux density is over 0.74 T, and due to the thickness of the ferrite, some flux lines may crowd in the edges and corners of the ferrite, and limited the effectiveness of the ferrite shielding.

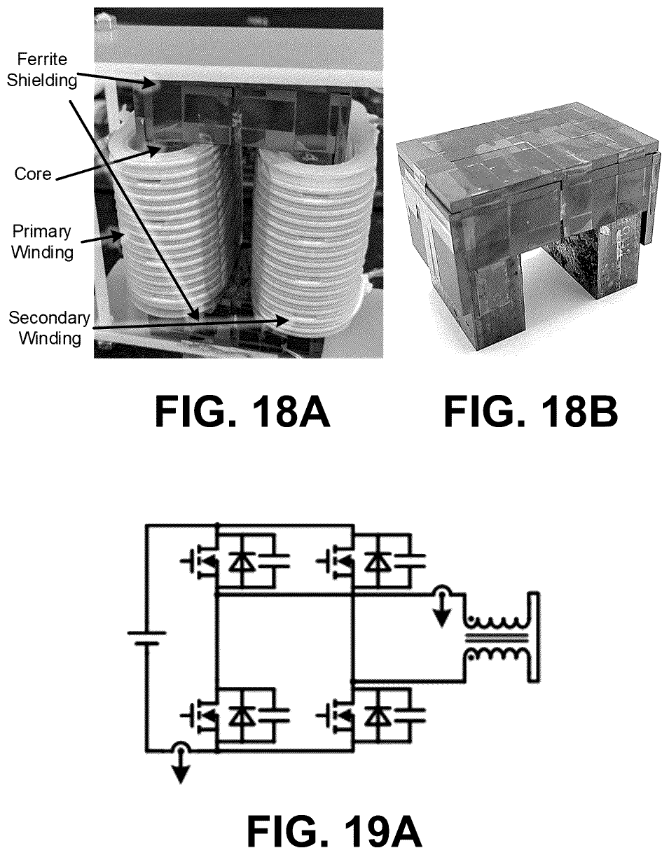

Ferrite Shielding on Core-Type Transformers. Similar analysis and test have also been performed on a core-type transformer for a 16 KW dual-active-bridge (DAB) converter. The transformer uses nanocrystalline core SC2062M1 with 31-to-31 turns on both sides, and the main transformer structure is shown in FIG. 18A and transformer core with ferrite shielding in FIG. 18B. Similarly, due to the thickness of the ferrite shielding, the height of the transformer was increased by 8 mm, which is two layers of the top and bottom side ferrite shielding, accounting for 6% of volume increase.

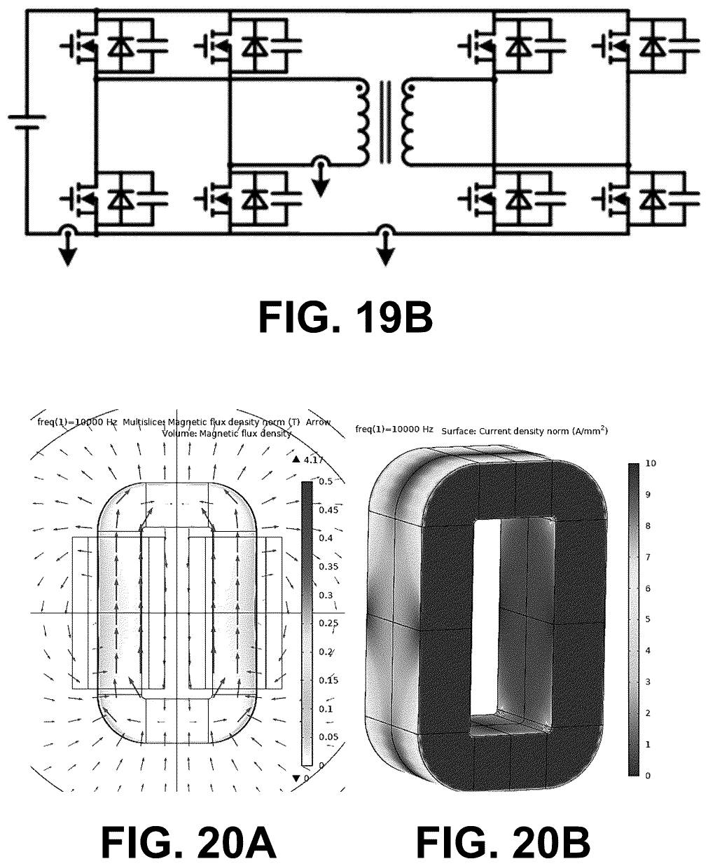

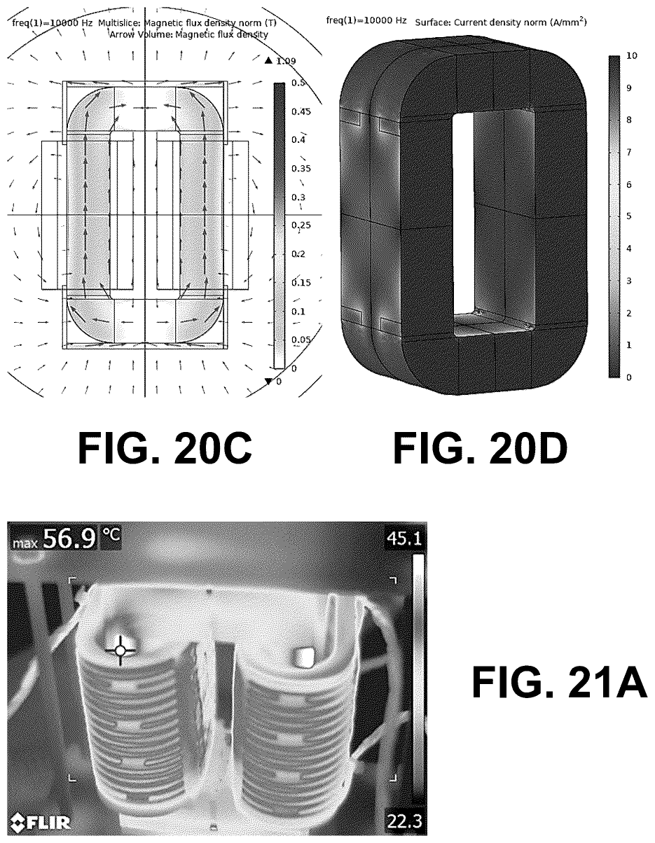

Simulation was also performed to validate the effectiveness of the proposed method. The results of leakage field in transformer short-circuit setup (see. FIG. 19A) are depicted in FIGS. 20A-20D. It can be seen from FIG. 20A, without any shielding, the leakage flux goes perpendicular to the core top and bottom surfaces, and hence eddy current is generated on the surfaces on the top and bottom of the lamination as shown in FIG. 20B. And, from FIG. 20C, with the proposed shielding on top and bottom of the core and side surfaces, the leakage flux is guided by the ferrite shielding at the top and bottom yokes of the core, and the flux with in the leg is also distributed more evenly, thanks to the bypassing effect of ferrite structure which reduces reluctance from inner lamination layers into the air. Then, FIG. 20D shows the surface current density with the proposed shielding, which is effectively reduced compared to that in FIG. 20B.

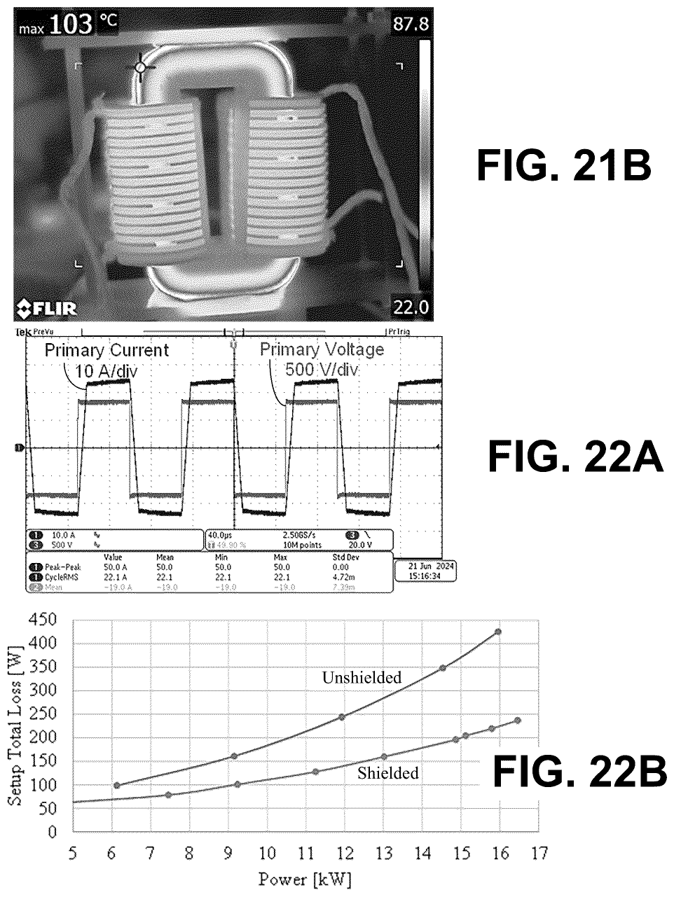

The core-type transformer has been put into a DAB converter as in FIG. 19B to perform a pump-back test to rule out any possible discrepancy during the short-circuit test. FIGS. 21A and 21B show thermal images during the test, from which can be seen that with the proposed shielding, the core hot spot temperature can be reduced by 46° C. FIG. 22A shows the transformer waveform on the primary side. Again, as the leakage and magnetizing inductances do not vary significantly between the shielded and unshielded cases, the transformer current waveforms in the two cases should resemble each other, ruling out the change of device loss, copper loss and magnetizing core losses. FIG. 22B shows the test results. From the loss curves, it can be seen that the DAB loss can be reduced greatly, especially at higher load level, and at approx. 16 KW, the reduction can be as high as around 189 W. From the loss comparison, it can be seen that the proposed ferrite shielding can effectively reduce the eddy current loss.

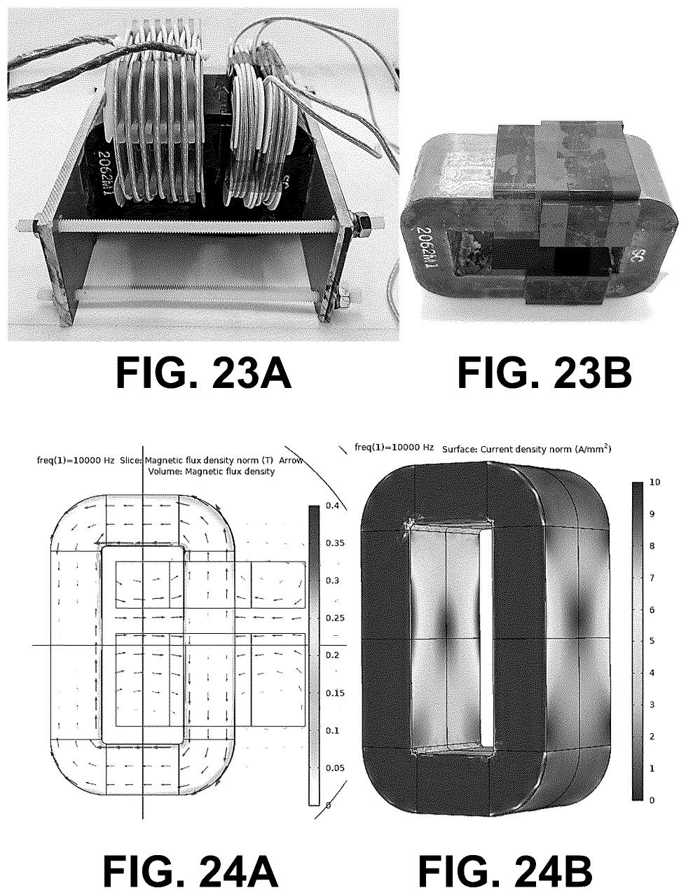

Ferrite Shielding on Shell-Type Transformers. The proposed shielding has also been implemented into the shell-type vertical stacked winding transformers. FIG. 23A shows a photograph of the transformer, and FIG. 23B shows the ferrite surrounding the transformer core. Due to the ferrite shielding added, the height of the shell-type transformer is increased by 4 mm, which causes 3.5% higher height and hence transformer volume.

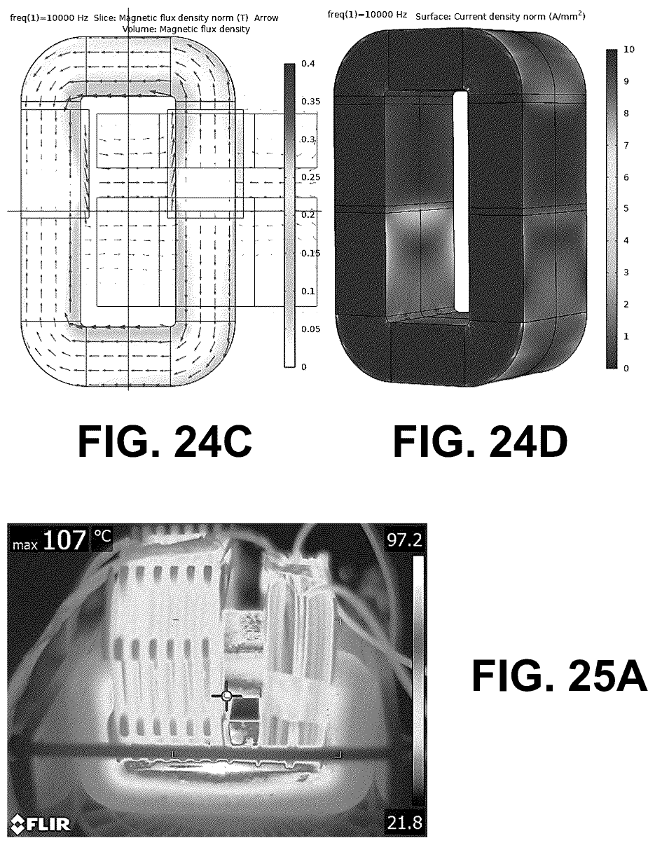

Similarly, simulation results are depicted in FIGS. 24A-24D. In FIG. 24A, the leakage flux goes through the nanocrystalline lamination in the space between the two windings, generating eddy current on the corresponding core surface as in FIG. 24B. With the ferrite shielding added in FIG. 24C, the leakage flux is redirected from the nanocrystalline core into the air, too. Therefore, the eddy current can be suppressed as shown in FIG. 24D, which validates the proposed shielding method for shell-type transformer.

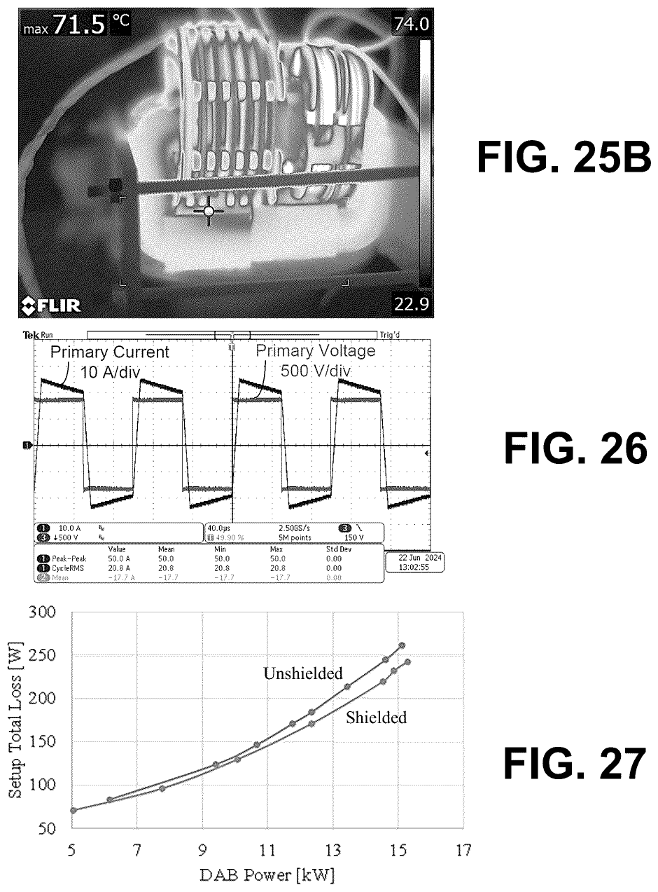

FIGS. 25A and 25B show thermal images during short-circuit test, showing that without the proposed shielding, the core surface inside the window is generating high loss and heat exceeding 100° C., while with the proposed ferrite shielding, the hotspot can be reduced to 74° C. The DAB tests were also performed for the shell-type transformer. FIG. 26 shows the test waveform of the transformer primary side. FIG. 27 shows the loss comparison between the transformer with and without ferrite shielding. As the DAB converting power from 7 KW to 15 KW, the loss reduction is getting higher, and reached around 20 W reduction at the full load, demonstrating the effectiveness of the shielding.

In this disclosure, a novel ferrite shielding method to suppress eddy current loss on inductors and transformers using ribbon-based nanocrystalline/amorphous cores has been discussed. A new ferrite shielding scheme has been proposed for both gapped inductors and leakage integrated transformers using ribbon-based cores. The proposed shielding ferrite technique has been implemented and validated in three cases: air gapped amorphous inductor, core-type nanocrystalline transformer, and shell-type nanocrystalline transformer. Through the simulation and test results, the proposed ferrite shielding was verified to suppress the stray flux induced eddy current core loss.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e., one atmosphere).

Therefore, at least the following is claimed:

1. A transformer, comprising:
a two dimensional (2D) laminated magnetic core;
a first winding wound about the 2D laminated magnetic core, the first winding configured for operation at a first voltage level; and
a second winding wound about the 2D laminated magnetic core adjacent to the first winding, the second winding configured for operation at a second voltage level less than the first voltage level.

2. The transformer of claim 1, wherein the 2D laminated magnetic core is a ribbon-based 2D laminated magnetic core comprising a plurality of wound ribbon cores, the plurality of wound ribbon cores stacked to provide lamination in a first dimension and each wound ribbon core providing lamination in a second dimension.

3. The transformer of claim 1, wherein the 2D laminated magnetic core is a sheet-based 2D laminated magnetic core comprising a plurality of parallel sheet laminated cores, the plurality of parallel sheet laminated cores nested within each other to provide lamination in a first dimension and each parallel sheet laminated core providing lamination in a second dimension.

4. The transformer of claim 1, wherein the 2D laminated magnetic core is a block-based 2D laminated magnetic core comprising a plurality of block laminated cores, the plurality of block laminated cores nested within each other to provide lamination in a first dimension and each block laminated core providing lamination in a second dimension.

5. The transformer of claim 1, wherein the 2D laminated magnetic core is a wire-based 2D laminated magnetic core comprising a wire core, the wire core providing lamination in first and second dimensions.

6. The transformer of claim 5, wherein the wire core comprises a narrow magnetic conductive wire.

7. The transformer of claim 5, wherein the wire-based 2D laminated magnetic core comprises a plurality of stacked wire cores.

8. The transformer of claim 1, wherein the 2D laminated magnetic core comprises silicon steel, nanocrystalline, or amorphous core laminations.

9. The transformer of claim 1, wherein the 2D laminated magnetic core is a split cut core.

10. The transformer of claim 1, comprising a shielding layer disposed between the 2D laminated magnetic core and at least one of the first winding or the second winding, the shield layer comprising a portion extending along a first side of the 2D laminated magnetic core substantially parallel to a lamination plane of the 2D laminated magnetic core.

11. The transformer of claim 10, wherein the shielding layer comprises second and third portions on opposite ends of the portion extending along the first side, the second and third portions extending along opposite sides of the 2D laminated magnetic core substantially perpendicular to the lamination plane.

12. The transformer of claim 11, wherein the shielding layer comprises ferrite.

13. The transformer of claim 11, wherein the shielding layer comprises a magnetic powder composite.

14. An inductor, comprising:
a two dimensional (2D) laminated magnetic core, the 2D laminated magnetic core comprising two halves separated by airgaps; and
a winding wound about the 2D laminated magnetic core.

15. The inductor of claim 14, wherein the 2D laminated magnetic core is a ribbon-based 2D laminated magnetic core comprising a plurality of wound ribbon cores, the plurality of wound ribbon cores stacked to provide lamination in a first dimension and each wound ribbon core providing lamination in a second dimension.

16. The inductor of claim 14, wherein the 2D laminated magnetic core is a sheet-based 2D laminated magnetic core comprising a plurality of parallel sheet laminated cores, the plurality of parallel sheet laminated cores nested within each other to provide lamination in a first dimension and each parallel sheet laminated core providing lamination in a second dimension.

17. The inductor of claim 14, wherein the 2D laminated magnetic core is a block-based 2D laminated magnetic core comprising a plurality of block laminated cores, the plurality of block laminated cores nested within each other to provide lamination in a first dimension and each block laminated core providing lamination in a second dimension.

18. The inductor of claim 14, wherein the 2D laminated magnetic core comprises silicon steel, nanocrystalline, or amorphous core laminations.

19. The inductor of claim 14, comprising a shielding layer disposed between the 2D laminated magnetic core and the winding, the shield layer comprising a portion extending along a first side of the 2D laminated magnetic core substantially parallel to a lamination plane of the 2D laminated magnetic core.

20. The inductor of claim 19, comprising a shielding layer disposed at edges of the airgaps.
